(19) United States
(12) Patent Application Publication
(10) Pub. No.: US 2022/0089505 A1
(43) Pub. Date: Mar. 24, 2022

(54) BIO-FERTILIZER AND METHOD FOR MANUFACTURING THE SAME

(71) Applicant: Shih-Lin Hsu, Diamond Bar, CA (US)

(72) Inventor: Shih-Lin Hsu, Diamond Bar, CA (US)

(21) Appl. No.: 17/029,961

(22) Filed: Sep. 23, 2020

(51) Int. Cl. C05F 11/10; C05F 17/40; C05F 17/60

(52) U.S. Cl. CPC C05F 11/10; C05F 17/60; C05F 17/40

(57) ABSTRACT

In one aspect, a method of preparing high quality homogenous slow-release bio-fertilizer that may include steps of preparing a liquid concentrate comprising nitrogen, potassium, phosphorus, ammonium nitrate, bacteria, one or more wetting agent, natural enzymes, azomite powders, trace mineral and basalt rock powders; adding said liquid concentrate to a biosolid; mixing the liquid concentrate-biosolid composition in a mixing means; and drying said composition. In one embodiment, a bio-fertilizer can be a homogenous organic base fertilizer for plant nutrition and soil fertility. Also, the fertilizer in the present invention can be added for plant nutrition and soil fertility, and concentrated liquid formulations/nutrient supplements can be added to the fertilizer in the present invention.

### FIELD OF THE INVENTION

The present invention relates to fertilizer compositions, and more particularly to a bio-fertilizer and the method for manufacturing same.

### BACKGROUND OF THE INVENTION

The continuous use of chemical pesticides and fertilizers on plants, bushes, and trees, and especially in agricultural settings in the production of crops, has created a variety of ecological problems. As the world and national populations have increased, farmers and horticulturalists have come to rely increasingly upon chemically synthesized fertilizers and chemical pesticides to maintain the same level of crop production.

More and more, organic base byproducts, including, but not limited to, biosolids, activated sludge, municipal compost, animal manures (such as cow, horse, pig, sheep, or chicken manure), and composted organic byproducts containing various plant nutrients, are being produced as a result of industrial and agricultural activities and processes. The nutrient content of these byproducts is generally low and these byproducts have been used as fillers, soil amendments or landfill because of their low nutrient value.

Turfgrasses, whether on a fairway, putting green or tee require rather large amounts of nitrogen fertilization during the growing season to maintain a desirable dark green color. There are numerous inorganic nitrogen fertilizer materials that can supply this needed nitrogen very adequately. However, these inorganic salts are very soluble in the soil solution and are readily converted to the nitrate form and leach, thus making frequent application of these materials necessary. Natural and synthetic slow-release organic nitrogen materials are available which release nitrogen over a longer period of time, thus reducing the frequency of application, while increasing the uniformity of turf growth and appearance throughout the season. Natural and synthetic slow-release nitrogen sources are influenced differently by the various environmental factors to which they are exposed. The present invention is advantageous because it increases the nutrient value of organic base byproducts and can be enhanced in such a way as to produce a high nutrient value homogenous organic-base fertilizer. Also, the fertilizers in the present invention have high nutrient values.

### SUMMARY OF THE INVENTION

In one aspect, the present invention provides a method for producing homogenous organic base fertilizer for plant nutrition and soil fertility. Also, the fertilizer in the present invention can be added for plant nutrition and soil fertility, and concentrated liquid formulations/nutrient supplements can be added to the fertilizer in the present invention. Methods according to the invention involve the application of concentrated liquid(s) and/or dry formulation(s) comprising a mixture of one or more plant nutrient(s), one or more additional organic compound(s), one or more penetrant(s), and one or more optional supplement(s) into one or more organic base material(s). These organic base materials include, and are not limited to, biosolids, activated sludge, municipal compost, animal manures (e.g., horse, cow, chicken, pig, and sheep), and composted organic byproducts.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In one aspect, a method of preparing homogenous bio-fertilizer that may include steps of preparing a liquid concentrate comprising nitrogen, potassium, phosphorus, ammonium nitrate, bacteria, humic acid, one or more wetting agent, natural enzymes, azomite powder, trace mineral and basalt rock powder; adding said liquid concentrate to a biosolid; mixing the liquid concentrate-biosolid composition in a mixing means; and drying said composition.

In one embodiment, the bio-fertilizer in the present invention can be concentrated liquid formulations (nutrient supplements). These liquid nutrient supplements can contain the following components: one or more plant nutrient(s), one or more organic compound(s), one or more penetrant(s), and/or one or more additional soil and plant additive(s). Plant nutrients may include macronutrients such as nitrogen (N), phosphorus (P), potassium (K), secondary nutrients such as calcium (Ca), magnesium (Mg), and micronutrients such as Iron (Fe), zinc (Zn), manganese (Mn), copper (Cu) and boron (B). Any combination of plant nutrients, macronutrients, secondary nutrients, and/or micronutrients can be used in the preparation of liquid formulations according to the present invention.

In one embodiment, methods according to the present invention involve the application of concentrated liquid(s) and/or dry formulation(s) comprising a mixture of one or more plant nutrient(s), one or more additional organic compound(s), and one or more penetrant(s), into one or more organic base material(s). Optionally, one or more beneficial microorganism(s) may be added to the organic base material(s). According to the invention, organic base materials may include, and are not limited to, biosolids, activated sludge, municipal compost, animal manures, and composted organic byproducts.

In another embodiment, organic compounds useful in the practice of the present invention may include, and are not limited to, biosolids, humic acid, fulvic acid and plant extracts. Plant extracts include, and are not limited to, seaweed extracts, kelp extracts, and/or the extracts of other plant materials. It is noted that the present invention allows for the incorporation of one or more organic compound(s), or combinations thereof, into the bio-fertilizer in the present invention.

In a further embodiment, organic base materials may include, and are not limited to, biosolids, activated sludge, municipal compost, animal manures (e.g., horse, cow, chicken, pig, and/or sheep), and composted organic byproducts. Other organic base materials include processed animal body and vegetable products such as blood meal, feather meal, cottonseed meal, ocean kelp meal, and fish fertilizers such as fish emulsions or meal.

Microorganisms useful in the practice of the invention can be selected from one or more of bacteria, fungi, and viruses that have utility in soil enhancement. Viruses such as the NPV viruses (nuclear polyhedrosis virus) and the cabbage looper nuclear polyhedrosis virus are examples of useful viruses. Any combination of one or more microorganisms may be used in the practice of the present invention.

Microorganisms (bacteria, fungi and viruses) that control various types of pathogens in the soil include microorganisms that control soil-born fungal pathogens, such as Trichoderma sp., Bacillus subtilis, Penicillium spp.; microorganisms that control insects, such as Bacillus sp., e.g., Bacillus popalliae; microorganisms that act as herbicides, e.g., Alternaria sp., and the like. These organisms are readily available from public depositories throughout the world.

Optional soil and/or plant additives that can be added to the fertilizer compositions of the invention include water trapping agents, such as zeolites; natural enzymes; growth hormones (such as the gibberellins, including gibberellic acid and gibberellin plant growth hormones); and control agents, including pesticides such as acaracides, molluskicides, insecticides, fungicides, nematocides, and the like.

In one embodiment, liquid nutrients are incorporated into organic base materials by spray application on palletized or granulated organic base materials. Alternatively, the liquid nutrients can be added via direct mixture into the organic base prior to granulation. In either embodiment, value added products for plant nutrition and soil fertility are produced.

In various embodiments, beneficial microorganisms can, optionally, be added to the organic base materials before, during, or after granulation or polarization of the organic base material. In one embodiment, beneficial microbes are added after the granulation or pelletization process.

Concentrated liquid formulation(s) may be applied to an organic base by spraying onto organic base materials as they enter, once they are already in, or as they exit a mixing means. Mixing means may include, and are not limited to, rotating mixers, other rotating containers, or granulation drums. The mixing means may rapidly rotate to mix and incorporate the liquid concentrate into the organic base materials. Concentrated liquid formulations or concentrated nutrient supplements are terms that may be used interchangeably throughout the specification.

Dry nutrient formulations may be applied to wet organic base materials prior to the drying and granulation process. The dry formulation(s) react with the wet organic base materials and are mixed through the process of granulation. Dry soluble macronutrient sources useful in the practice of the present invention may include nitrogen sources, such as ammonium sulfate; and potassium sources, such as potassium nitrate, potassium phosphate, and potassium sulfate.

In one embodiment, liquid nutrients are incorporated into organic base materials by spray application on pelletized or granulated organic base materials. Alternatively, the liquid nutrients can be added via direct mixture into the organic base prior to granulation. In either embodiment, value added products for plant nutrition and soil fertility are produced.

The concentrated liquid formulation(s) and the dry formulation(s) may vary according to type and concentrations of plant nutrients depending on the desired end formulation for the homogenous organic-base granular fertilizer. These formulations may be varied to provide the desired nutritional components for a particular crop, plant, or grass.

Concentrated liquid formulation(s) may be applied to an organic base by spraying onto organic base materials as they enter, once they are already in, or as they exit a mixing means. Mixing means include, and are not limited to, rotating mixers, other rotating containers, or granulation drums. The mixing means may rapidly rotate to mix and incorporate the liquid concentrate into the organic base materials.

Dry nutrient formulations may be applied to wet organic base materials prior to, during, or after the drying and granulation process. The dry formulation(s) react with the wet organic base materials and are mixed through the process of granulation.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A method of preparing homogenous bio-fertilizer that may include steps of:
preparing a liquid concentrate comprising nitrogen, potassium, phosphorus, ammonium nitrate, bacteria, one or more wetting agent, natural enzymes, azomite powders, trace mineral and basalt rock powders;
adding said liquid concentrate to a biosolid;
mixing the liquid concentrate-biosolid composition in a mixing means; and
drying said composition.

2. The method of preparing homogenous bio-fertilizer of claim 1, wherein the bio-fertilizer can be concentrated liquid formulations including following components: one or more plant nutrient(s), one or more organic compound(s), one or more penetrant(s), and/or one or more additional soil and plant additive(s).

3. The method of preparing homogenous bio-fertilizer of claim 2, wherein the organic compounds includes biosolids, humic acid, fulvic acid and plant extracts.
